(19) United States
(12) Patent Application Publication
(10) Pub. No.: US 2012/0294202 A1
(43) Pub. Date: Nov. 22, 2012

(54) METHOD OF COMMUNICATION

(76) Inventors: Jin Gon Joung, Singapore (SG); Sumei Sun, Singapore (SG)

(21) Appl. No.: 13/575,920

(22) PCT Filed: Jan. 17, 2011
(86) PCT No.: PCT/SG11/00023

§ 371 Date: Jul. 27, 2012

(30) Foreign Application Priority Data
Jan. 27, 2010 (SG) 201000671-6

(51) Int. Cl. H04J 11/00; H04B 7/14

(52) U.S. Cl. 370/279

(57) ABSTRACT

A method of communication comprising: at time=t: a first multiple antenna relay node decoding and forwarding a first STBC coded signal from a source node, and a first decoded and forwarded STBC signal from a second multiple antenna relay node, and a destination DSTTD receiver decoding the first STBC coded signal from the source node, and the first decoded and forwarded STBC signal from the second multiple antenna relay node; at time=t+1: the second multiple antenna relay node receiving a second STBC coded signal from the source node, and a second decoded and forwarded signal from the first multiple antenna relay node, and the destination DSTTD receiver decoding the second STBC coded signal from the source node, and the second decoded and forwarded signal from the first multiple antenna relay node.

### FIELD OF THE INVENTION

The present invention relates to a method of communication.

### BACKGROUND

In point-to-point (PtoP) communications, there is a restriction on the transmit power of the transmitter due to the cost and complexity of radio frequency (RF) chain including many amplifiers, filters, and digital-to-analogue converters. To enhance the communication performance under these circumstances, multiple transmitters cooperating with low power have been considered as candidates for future communications. Examples of such cooperative communication protocols with relays are physical layer network coding, analogue network coding, and various hybrid methods. However, the relaying protocols mentioned suffer from spectral efficiency loss due to the two channel uses required for the transmission and reception at the relay nodes. In other words, since a half-duplex (HD) relay cannot simultaneously receive and transmit signals, additional time, frequency, and/or code resources are required.

### SUMMARY OF THE INVENTION

In general terms the invention relates to double space-time transmit diversity two path relay systems. The invention may also relate to phase rotation processing at the relay nodes, link selection based on signal to noise ratio (SNR), frame structure including training sequence, transmit- and receive-modes of two relays and/or cell planning strategies. This may have the advantage of reduced co-channel interference (CCI) between the relay nodes, reduced inter cell interference (ICI), reduced bit error rate and/or reduced quantity of feedback information.

In a first specific expression of the invention there is provided a method of communication comprising:

At time=t:
a first multiple antenna relay node decoding and forwarding a first STBC coded signal from a source node, and a first decoded and forwarded STBC signal from a second multiple antenna relay node, and
a destination DSTTD receiver decoding the first STBC coded signal from the source node, and the first decoded and forwarded STBC signal from the second multiple antenna relay node;

At time=t+1:
the second multiple antenna relay node receiving a second STBC coded signal from the source node, and a second decoded and forwarded signal from the first multiple antenna relay node, and
the destination DSTTD receiver decoding the second STBC coded signal from the source node, and the second decoded and forwarded signal from the first multiple antenna relay node.

The method may further comprise phase rotation pre-processing.

The method may further comprise optimising a pre-processing matrix based on a post-processed SNR.

A direct link or a relay link may be selected based on a post-processed SNR at the destination DSTTD receiver.

The decoding and forwarding may include DSTTD detection.

The method may further comprise channel estimating based on an orthogonal training sequence in a frame structure for each of the STBC coded signals and decoded and forwarded signal signals.

A cell may be divided into sectors, each sector having an orthogonal frequency band, and the first multiple antenna relay node and the second multiple antenna relay node may be selected within each sector.

A cluster may be formed out of a plurality of adjacent cells, wherein a first sector in a first cell and a second sector in a second cell may share the same frequency band, and wherein selecting the first multiple antenna relay node and the second multiple antenna relay node may comprise selecting a relay node in the first sector that is closest to the second sector as either the first multiple antenna relay node or the second multiple antenna relay node, and selecting a relay node in the second sector that is closest to the first sector as the either the second multiple antenna relay node or the first multiple antenna relay node respectively.

The STBC coded signals and decoded and forwarded signal signals may comprise a two-path relay time-division-duplex (TDD) frame structure, wherein the frame structure may include slots for uplink data transfer, downlink data transfer feedback on phase rotation, and feedback on link selection.

The method may further comprise bi-directional communication including an uplink and a downlink.

An integrated circuit may communicate according to the method.

A mobile station may communicate according to the method.

A base station may communicate according to the method.

A relay station may communicate according to the method.

In a second specific expression of the invention there is provided a communication system comprising
a multiple antenna source configured to transmit STBC coded signals
at least two multiple antenna DSTTD relay nodes configured to alternatively decode and forward the STBC coded signals, and
a DSTTD receiver configured to decode the STBC coded signals and the relayed signals.

Certain embodiments of the method of transmission of the present invention may have one or more of the advantages of:
having performance improvements over prior art systems, e.g. PtoP direct communication systems;
having a lower bit error rate (BER) when compared to prior art systems;
using a minimal about of feedback information to bring about an improved system performance;
having a spectral efficiency that is the same as that for a full-duplex system;
reduced inter-relay interference;
reduced inter-cell interference; and
reducing or eliminating the noise collected at, the relays that is forwarded on to the destination when compared to prior art systems, e.g. systems using amplify-and-forward relaying.

### BRIEF DESCRIPTION OF THE DRAWINGS

One or more example embodiments of the invention will now be described, with reference to the following figures, in which:

FIG. 1 is a schematic drawing showing a method of transmission according to the example embodiment;

FIG. 2(a) is a schematic drawing showing the structure of a tth space-time block coded frame at a source for a time slot t as used in the method of FIG. 1;

FIG. 2(b) is a schematic drawing showing the structure of a tth space-time block coded frame at a relay node for a time slot t as used in the method of FIG. 1;

FIG. 3 is a schematic drawing showing the transmission pattern of the nodes across different time slots as used in the method of FIG. 1;

FIG. 4 is a schematic drawing showing an efficient cell plan for use in the method of FIG. 1;

FIG. 5 is a schematic drawing showing a cluster structure for the cell plan of FIG. 4;

FIG. 6(a) is a schematic diagram showing the spectrum usage of a conventional point-to-point Time Division Multiplexing (TDD)/Orthogonal frequency-division multiple access (OFDMA) communication for a frame of a base station;

FIG. 6(b) is a schematic diagram showing the spectrum usage of a conventional point-to-point TDD/OFDMA communication as in FIG. 6(a), but for a user node;

FIG. 7(a) is a schematic diagram showing the spectrum usage of TDD/OFDMA communications for a frame of a base station in the method of FIG. 1;

FIG. 7(b) is a schematic diagram showing the spectrum usage of TDD/OFDMA communications as in FIG. 7(a), but for a user node;

FIG. 7(c) is a schematic diagram showing the spectrum usage of TDD/OFDMA communications as in FIG. 7(a), but for a first relay node;

FIG. 7(d) is a schematic diagram showing the spectrum usage of TDD/OFDMA communications as in FIG. 7(a), but for a second relay node;

FIG. 8(a) is a graph comparing the BER performance of the direct and relay links for DSTTD-based two-path relay communications as the received SNR for the link from the source to the destination is varied;

FIG. 8(b) is a graph comparing the BER performance of the direct and relay links for DSTTD-based two-path relay communications as the received SNRs for the links from the source to the relays are varied;

FIG. 9(a) is a graph comparing the BER performance under different feedback conditions for DSTTD-based two-path relay communications as the received SNR for the link from the source to the destination is varied;

FIG. 9(b) is a graph comparing the BER performance under different feedback conditions for DSTTD-based two-path relay communications as the received SNRs for the links from the source to the relays are varied; and

FIG. 10 is a flow-chart showing the method of transmission of FIG. 1 across different time slots.

### DETAILED DESCRIPTION

The following notations may be used in this specification. For a vector or matrix, the superscripts ‘T’ and ‘*’ respectively denote a transposition and a complex conjugate transposition. For a scalar w, the notation |w| denotes the absolute value of w. For a matrix W, the notation ∥W∥_{F} denotes the Frobenius-norm of W. 0_{w} denotes a w-by-w zero matrix and I_{w} denotes a w-by-w identity matrix. The notation W¹ denotes a matrix inversion of the matrix W. [W]_{l,l} denotes the lth diagonal element of W. E[•] denotes the expectation of a random variable.

FIG. 1 shows a method 100 of transmission according to the example embodiment. The transmission uses two-path double space-time transmit diversity (DSTTD) and takes place from a source S 102 to a destination D 120 via relay stations R1 110 and R2 112. The relay stations R1 110 and R2 112 may relay in a decode-and-forward (DF) manner. In contrast with systems using other forms of relay, e.g. the amplify-and-forward relaying, the usage of DF may have the advantage of reducing or eliminating the noise collected at the relay that is forwarded on to the destination.

In this specification, the term “node” is used to refer to a device functioning as a source, a relay station, or a destination in the method 100. The transmission occurs over multiple time slots. As an example, the transmission pattern of the nodes for two slots t=2 and t=3 are shown in FIG. 1. In t=2, the S 102 and R1 110 function as transmitters while R2 112 and D 120 function as receivers. In t=3, S 102 and R2 112 function as transmitters while R1 110 and D 120 function as receivers.

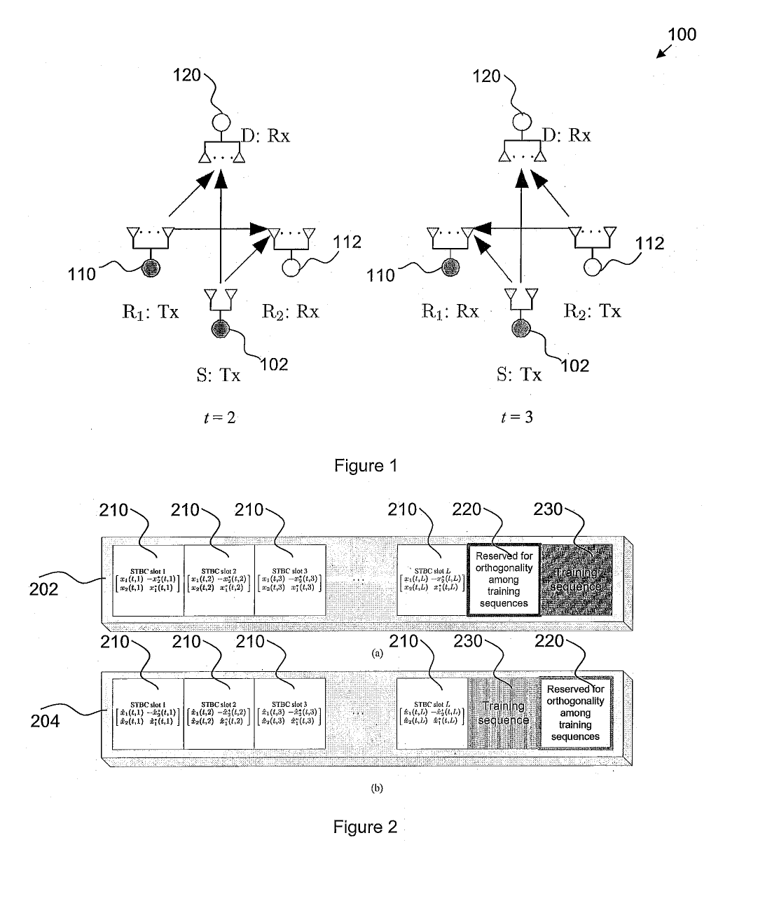

FIG. 2 shows the structure of, (a) a tth space-time block coded (STBC) frame 202 at a source S 102 for a time slot t, and (b) a tth STBC frame 204 at a relay node for a time slot t. FIG. 2 is illustrated with a time-domain orthogonal structure but the structure may be applied to an orthogonal frequency-division multiplexing (OFDM) system over frequency domain.

The tth STBC frames 202, 204 have a time-domain orthogonal structure each comprise L STBC blocks 210. The frame may also comprise one or more training blocks 230 containing training sequences for optionally carrying out channel estimation on relay and/or direct links. The training sequences are arranged to have an orthogonal training structure. The optional channel estimation may be performed when any node is functioning as a receiver.

Each node used in the method 100 has two antennae. It is however also envisaged that the nodes may each have more than two antennae. The data to be transmitted may thus be represented by blocks of 2-by-2 STBC symbols with the rows of the blocks respectively representing the data for each antenna. The information in the L STBC blocks may accordingly be represented as

$$[ [ \begin{matrix}{x}_{1} ( t , 1 ) & - {x}_{2}^{*} ( t , 1 ) \\ {x}_{2} ( t , 1 ) & {x}_{1}^{*} ( t , 1 )\end{matrix} ] … [ \begin{matrix}{x}_{1} ( t , L ) & - {x}_{2}^{*} ( t , L ) \\ {x}_{2} ( t , L ) & {x}_{1}^{*} ( t , L )\end{matrix} ] ] \qquad ( 1 )$$

where xₙ(t, l) is a transmit symbol satisfying E|xₙ(t, l)|²=Es, and nε{1, 2} represents the symbol index in the lth STBC block and E_{S} is an average symbol energy.

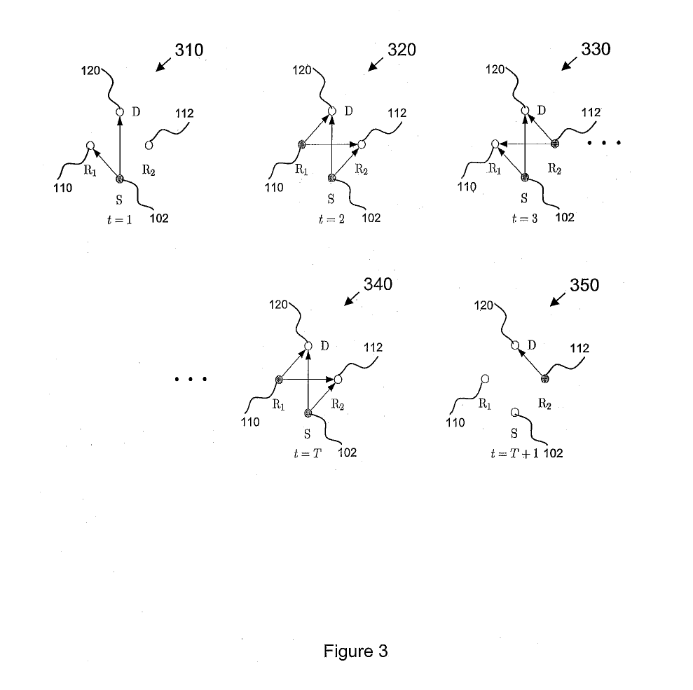

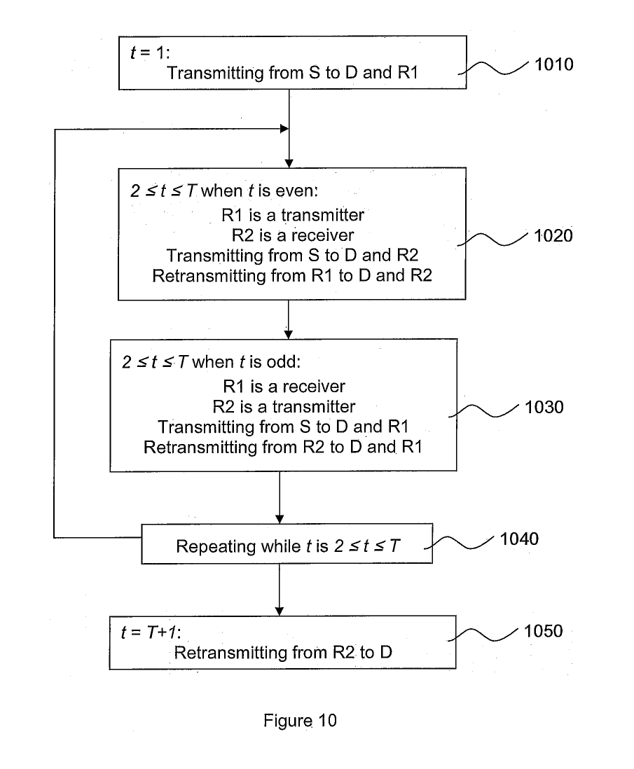

FIG. 10 is a flow chart showing the method 100 of transmission across different time slots. FIG. 3 shows the transmission patterns of the nodes across the different time slots. The method 100 of transmission will be described next with the aid of FIGS. 10 and 3. Assuming that the source S 102 has T frames of data to transmit to the destination D 120, the method 100 uses T+1 transmission time slots to completely transmit the data. Without any loss of generality, it is assumed that T is even number. T however may be an odd number. As an example, L=1 is used for simple description. L however may be any other number.

In the description that follows, the following notations are used. In all notations, the index representing the STBC block is omitted. y_{N,m,n}(t) denotes the signal received at the mth antenna of the node Nε{D,R1,R2}, for the sequential receive time index nε{1, 2} of STBC symbol of the tth frame. n_{N,m,n}(t) denotes additive white Gaussian noise (AWGN) with zero mean and σ_{N}² variance corresponding to the Y_{N,m,n}(t).

H_{N}_{₂}_{N}_{₁}(t) is a 2-by-2 matrix used to denote the MIMO channel from the node N1 to node N2 such that N1 and N2ε{D,R1,R2,S}.

$${H}_{{N}_{2} {N}_{1}} ( t ) = [ \begin{matrix}{h}_{{N}_{2} {N}_{1} , 1 , 1} ( t ) & {h}_{{N}_{2} {N}_{1} , 1 , 2} ( t ) \\ {h}_{{N}_{2} {N}_{1} , 2 , 1} ( t ) & {h}_{{N}_{2} {N}_{1} , 2 , 2} ( t )\end{matrix} ] \qquad ( 2 )$$

x_{N,n}(t) denotes the nth STBC symbol of the tth frame at the Nth node. \hat{x}_{N,n}(t) denotes an estimated version of x_{N,n}(t)

The method 100 will now be described in three parts i.e. the first STBC frame part (t=1), the DSTTD frame part (2=t=T), and the last STBC frame part (t=T+1).

A. First STBC Frame Part (t=1)

In 1010, the time is t=1 and S 102 transmits to R1 110 and D 120. This is illustrated in the transmission pattern 310 of FIG. 3. Making an assumption that the channel is static for two consecutive symbols, the signal received at D 120 at the initial time t=1 can be written as

$$[ \begin{matrix}{y}_{D , 1 , 1} ( 1 ) & {y}_{D , 1 , 2} ( 1 ) \\ {y}_{D , 2 , 1} ( 1 ) & {y}_{D , 2 , 2} ( 1 )\end{matrix} ] = [ \begin{matrix}{0}_{2} & {H}_{DS} ( 1 )\end{matrix} ] [ \begin{matrix}{0}_{2} \\ [ \begin{matrix}{x}_{1} ( 1 ) & - {x}_{2}^{*} ( 1 ) \\ {x}_{2} ( 1 ) & {x}_{1}^{*} ( 1 )\end{matrix} ]\end{matrix} ] + [ \begin{matrix}{n}_{D , 1 , 1} ( 1 ) & {n}_{D , 1 , 2} ( 1 ) \\ {n}_{D , 2 , 1} ( 1 ) & {n}_{D , 2 , 2} ( 1 )\end{matrix} ] \qquad ( 3 )$$

After reformulating the received signals, the linear model obtained is

$$\begin{matrix}[ \begin{matrix}{y}_{D , m , 1} ( 1 ) \\ {y}_{D , m , 2}^{*} ( 1 )\end{matrix} ] = {y}_{D , m} ( 1 ) \\ = [ \begin{matrix}{h}_{DS , m , 1} ( 1 ) & {h}_{DS , m , 2} ( 1 ) \\ {h}_{DS , m , 2}^{*} ( 1 ) & - {h}_{DS , m , 1}^{*} ( 1 )\end{matrix} ] [ \begin{matrix}{x}_{1} ( 1 ) \\ {x}_{2} ( 1 )\end{matrix} ] + [ \begin{matrix}{n}_{D , m , 1} ( 1 ) \\ {n}_{D , m , 2}^{*} ( 1 )\end{matrix} ] \\ = {S}_{D , m} ( 1 ) ⌈ \begin{matrix}{x}_{1} ( 1 ) \\ {x}_{2} ( 1 )\end{matrix} ⌉ + {n}_{D , m} ( 1 )\end{matrix} \qquad ( 4 )$$

S_{D,m}(1) is a 2-by-2 matrix modelling the effective STBC channel from the S 102 to the mth antenna of the D 120 and n_{D,m}(1)εC^{2×1} is a vector modelling AWGN.

After multiplying (4) with S*_{D,m}(1) and combining over m, we have

$${\sum }_{m = 1}^{2} {S}_{D , m}^{*} ( 1 ) {y}_{D , m} ( 1 ) = {‖ {H}_{DS} ( 1 ) ‖}_{F}^{2} [ \begin{matrix}{x}_{1} ( 1 ) \\ {x}_{2} ( 1 )\end{matrix} ] + {n}_{D} ( 1 ) \qquad ( 5 )$$

where n_{D}(t)=Σₘ₌₁²S*_{D,m}(1)n_{D,m}(1) is a noise vector after equalization. Estimates of x_{D,1}(1) and x_{D,2}(1) may be obtained from the combined signal of Equation 5 by using a maximum likelihood (ML) or linear decoder. These estimates are respectively denoted \hat{x}_{D,1}(1) and \hat{x}_{D,2}(1).

At the same initial time t=1, R1 110 receives at its antennae

$$[ \begin{matrix}{y}_{{R}_{1} , 1 , 1} ( 1 ) & {y}_{{R}_{1} , 1 , 2} ( 1 ) \\ {y}_{{R}_{1} , 2 , 1} ( 1 ) & {y}_{{R}_{1} , 2 , 2} ( 1 )\end{matrix} ] = [ \begin{matrix}{0}_{2} & {H}_{{R}_{1} S} ( 1 )\end{matrix} ] [ \begin{matrix}{0}_{2} \\ [ \begin{matrix}{x}_{1} ( 1 ) & - {x}_{2}^{*} ( 1 ) \\ {x}_{2} ( 1 ) & {x}_{1}^{*} ( 1 )\end{matrix} ]\end{matrix} ] + [ \begin{matrix}{n}_{{R}_{1} , 1 , 1} ( 1 ) & {n}_{{R}_{1} , 1 , 2} ( 1 ) \\ {n}_{{R}_{1} , 2 , 1} ( 1 ) & {n}_{{R}_{1} , 2 , 2} ( 1 )\end{matrix} ] \qquad ( 6 )$$

Similarly, estimates of x_{R1,1}(1) and x_{R1,2}(1) may be obtained by using a maximum likelihood (ML) or linear decoder as is done in the node D 120. These estimates are respectively denoted \hat{x}_{R1,1}(1) and \hat{x}_{R1,2}(1). The estimates \hat{x}_{R1,1}(1) and \hat{x}_{R1,2}(1) then may be retransmitted or relayed on from R1 110 to the nodes D 120 and/or R2 112.

B. DSTTD Frame Part (2=t=T)

In 1020, the time t is 2=t=T and is even. S 102 transmits to R2 112 and D 120 while R1 110 retransmits what it had received earlier on to R2 112 and D 120. This is illustrated in the transmission pattern 320 of FIG. 3 for the time t=2.

In 1030, the time t is 2=t=T and is odd. S 102 transmits to R1 110 and D 120 while R2 112 retransmits what it had received earlier to R1 110 and D 120. This is illustrated in the transmission pattern 330 of FIG. 3 for the time t=3.

In each time slot in (2=t=T), the S 102 node transmits fresh STBC symbols denoted with {x₁(t), x₂(t)} to the nodes D 120 and Rₐ, where Rₐε{R1, R2}. In the same time slot, the STBC symbols retransmitted by the nodes R1 110 or R2 112 are denoted by {\hat{x}_{R}_{_{b}}_{,1}(t−1), \hat{x}_{R}_{_{b}}_{,2}(t−1)} where R_{b}ε{R1, R2} such that Rₐ≠R_{b}. {\hat{x}_{R}_{_{b}}_{,1}(t−1),\hat{x}_{R}_{_{b}}_{,2}(t−1)} are the symbols estimated at R_{b} in the previous time slot. For example, at t=2, R1 110 retransmits the estimates \hat{x}_{R1,1}(1) and \hat{x}_{R1,2}(1) to the nodes D 120 and R2 112.

It is assumed that the transmit power of the relay nodes R1 110 and R2 112 are the same as that of the source, i.e., E|\hat{x}_{R}_{_{b,i}}|²=Es. In the following description, when t is an odd number, the notation of {Rₐ, R_{b}}={R1, R2} is used. When t is an even number, the notation of {Rₐ, R_{b}}={R2, R1} is used. In both cases, R_{b} performs relaying while S transmits fresh STBC data symbols. S 102 and R_{b} may transmit their respective two independent STBC frames simultaneously. It can thus be seen that the relay nodes R1 110 and R2 112 alternatively switch between transmitting and receiving modes from one time slot to the next. The spectral efficiency may thus be seen to be the same as that for a full-duplex relay system.

At the time slot t, the signal received at the D node may thus be interpreted as one DSTTD frame and may be represented as

$$[ \begin{matrix}{y}_{D , 1 , 1} ( t ) & {y}_{D .1 , 2} ( t ) \\ {y}_{D .2 .1} ( t ) & {y}_{D , 2.2} ( t )\end{matrix} ] = [ \begin{matrix}{H}_{{DR}_{b}} ( t ) & {H}_{DS} ( t )\end{matrix} ] P [ \begin{matrix}{\hat{x}}_{{R}_{b} .1} ( t - 1 ) & - {\hat{x}}_{{R}_{b} .1}^{*} ( t - 1 ) \\ {\hat{x}}_{{R}_{b} .2} ( t - 1 ) & {\hat{x}}_{{R}_{b} .1}^{*} ( t - 1 ) \\ {x}_{1} ( t ) & - {x}_{2}^{*} ( t ) \\ {x}_{2} ( t ) & {x}_{1}^{*} ( t )\end{matrix} ] + [ \begin{matrix}{n}_{D .1 .1} ( t ) & {n}_{D .1 .2} ( t ) \\ {n}_{D .2 .1} ( t ) & {n}_{D .2 .2} ( t )\end{matrix} ] \qquad ( 7 )$$

where P is a 4-by-4 pre-processing matrix.

As the receiver may be a conventional DSTTD receiver, the signal received as represented in Equation 7 may be reordered to yield a linearized model.

y_{D}(t)=S_{D}(t)x(t)+n_{D}(t) (8)

The notation y_{N}(t)=[y_{N,1,1}(t)y*_{N,1,2}(t)y*_{N,2,2}(t)]^{T} denotes a received signal vector at the node N. S_{D}(t) is a 4-by-4 effective DSTTD channel matrix. x(t)=[\hat{x}_{R}_{_{b}}_{,1}(t−1)\hat{x}_{R}_{_{b}}_{,2}(t−1)x₁(t)x₂(t)]^{T} is a transmitted symbol vector. Estimates of x(t) may be obtained from the reordered signal from Equation 8 by using a ML or linear decoder. This estimation may be done at the D 120. The estimates obtained are denoted \hat{x}(t)=[\hat{x}_{R}_{_{b}}_{,D,1}(t−1)\hat{x}_{R}_{_{b}}_{,D,2}(t−1)\hat{x}_{D,1}(t)\hat{x}_{D,2}(t)]^{T}, the elements of \hat{x}(t) respectively being estimates of the corresponding elements from x(t).

Similarly, the signal received at the relay node Rₐ may be expressed as

y_{R}_{ₐ}(t)=S_{R}_{ₐ}(t)x(t)+n_{R}_{ₐ}(t) (9)

The relay node Rₐ may also employ ML or linear detector to obtain an estimate of x(t)=[x_{R}_{ₐ}_{,1}(t)x_{R}_{ₐ}_{,2}(t)]^{T}. The estimates obtained are denoted \hat{x}(t)=[\hat{x}_{R}_{ₐ}_{,1}(t)\hat{x}_{R}_{ₐ}_{,2}(t)]^{T}.

In the subsequent time slot t+1, it is noted that where Rₐ=R1, R1 becomes denoted by R_{b}. Similarly, where Rₐ=R2, R2 becomes denoted by R_{b}. In other words, the relay, node Rₐ that does receiving in the time slot t, performs retransmission or relaying under the node notation of R_{b} in the time slot t+1. Accordingly, the estimates \hat{x}(t)=[\hat{x}_{R}_{ₐ}_{,1}(t)\hat{x}_{R}_{ₐ}_{,2}(t)]^{T} obtained in Rₐ in the time slot t become denoted by \hat{x}(t)=[\hat{x}_{R}_{_{b}}_{,1}(t)\hat{x}_{R}_{_{b}}_{,2}(t)]^{T} in the time slot t+1. In the time slot t+1, \hat{x}(t)=[\hat{x}_{R}_{_{b}}_{,1}(t)\hat{x}_{R}_{_{b}}_{,2}(t)]^{T} is thus retransmitted from the node R_{b} to the nodes Rₐ and D 120.

In 1040, while t is 2≦t≦T, the steps of 1020 and 1030 are repeated. Thus the step 1020 is performed for every even numbered time slot from t=4 to t=T. The transmission pattern 340 shows the transmission between nodes for the time slot t=T. Accordingly, the step 1030 is performed for every odd numbered time slots from t=5 to t=T−1.

The transmission pattern during each of the time slots of 2≦t=T thus may be generalized as transmitting from the S 102 node to the D 120 node a DSTTD signal, while in the same time slot receiving the same signal at a relay node, just as the other relay node transmits a DSTTD signal that was previously received in an earlier time slot. In the next time slot the same thing happens, except the relay nodes change roles; the receiving one transmits and vice versa. Since the D 120 receives a DSTTD signal directly from the S 102 and R1 110 (or R2 112), the D 120 may function like a PtoP DSTTD system and may thus employ a DSTTD receiver.

C. Last STBC Frame Part (t=T+1)

In 1050, the time is t=T+1 and R2 112 retransmits to D 120 what it has received in the time slot T. In other words, R2 112 relays on to D 120 \hat{x}(T)=[\hat{x}_{R}_{₂}_{,1}(T)\hat{x}_{R}_{₂}_{,2}(T)]^{T}. This is illustrated in the transmission pattern 350 of FIG. 3.

The signal received at D 120 is

$$[ \begin{matrix}{y}_{D , 1.1} ( T + 1 ) & {y}_{D .1 .2} ( T + 1 ) \\ {y}_{D .2 , 1} ( T + 1 ) & {y}_{D .2 .2} ( T + 1 )\end{matrix} ] = [ \begin{matrix}{H}_{{DR}_{2}} ( T + 1 ) & {0}_{2}\end{matrix} ] [ \begin{matrix}[ \begin{matrix}{\hat{x}}_{{R}_{2} , 1} ( T ) & - {\hat{x}}_{{R}_{2} .2}^{*} ( T ) \\ {\hat{x}}_{{R}_{2} .2} ( T ) & {\hat{x}}_{{R}_{2} .1}^{*} ( T )\end{matrix} ] \\ {0}_{2}\end{matrix} ] + [ \begin{matrix}{n}_{D .1 .1} ( T + 1 ) & {n}_{D .1 .2} ( T + 1 ) \\ {n}_{D .2 .1} ( T + 1 ) & {n}_{D , 2.2} ( T + 1 )\end{matrix} ] \qquad ( 10 )$$

After reformulating the received signal of Equation 10, a linear model may be obtained as

$$\begin{matrix}[ \begin{matrix}{y}_{D , m , 1} ( T + 1 ) \\ {y}_{D , m , 2}^{*} ( T + 1 )\end{matrix} ] = {y}_{D , m , 1} ( T + 1 ) \\ = [ \begin{matrix}{h}_{{DR}_{2} , m , 1} ( T + 1 ) & {h}_{{DR}_{2} , m , 2} ( T + 1 ) \\ {h}_{{DR}_{2} , m , 2} ( T + 1 ) & - {h}_{{DR}_{2} , m , 1}^{*} ( T + 1 )\end{matrix} ] [ \begin{matrix}{\hat{x}}_{{R}_{2} , 1} ( T ) \\ {\hat{x}}_{{R}_{2} , 2} ( T )\end{matrix} ] + \\ [ \begin{matrix}{n}_{D , m , 1} ( T + 1 ) \\ {n}_{D , m , 2}^{*} ( T + 1 )\end{matrix} ] \\ = {S}_{D , m , 1} ( T + 1 ) [ \begin{matrix}{\hat{x}}_{{R}_{2} , 1} ( T ) \\ {\hat{x}}_{{R}_{2} , 2} ( T )\end{matrix} ] + {n}_{D , m} ( T + 1 )\end{matrix} \qquad ( 11 )$$

S_{D,m}(T+1) is a 2-by-2 matrix modelling the effective STBC channel from R2 112 to the mth antenna of the D 120 and n_{D,m}(T+1)εC^{2×1} is a vector modelling AWGN.

As was done to Equation 4 in order to obtain Equation 5, Equation 12 that follows may also be obtained from Equation 11.

$${\sum }_{m = 1}^{2} {S}_{D , m}^{*} ( T + 1 ) {y}_{D , m} ( T + 1 ) = {‖ {H}_{{DR}_{2}} ‖}_{F}^{2} [ \begin{matrix}{\hat{x}}_{{R}_{2} , 1} ( T ) \\ {\hat{x}}_{{R}_{2} , 2} ( T )\end{matrix} ] + {n}_{D} ( T + 1 ) \qquad ( 12 )$$

Estimates of x_{D,1}(T) and x_{D,2} (T) may be obtained from the signal of Equation 12 by using a maximum likelihood (ML) or linear decoder. These estimates are respectively denoted \hat{x}_{R}_{₂}_{,1}(T) and \hat{x}_{R}_{₂}_{,2}(T).

### III. Pre-Processing Design

Comparing the method 100 to a typical point-to-point (PtoP) communication system, S and R_{b}ε{R1, R2} when performing DSTTD cooperative transmission according to the method 100 may be viewed as a single DSTTD transmitting device with four antennae. A pre-processing method may be used to improve system performance with some feedback information, for example methods using antenna shuffling and/or selection.

Optionally, distributed pre-processing may be used where a block diagonal matrix with the form of P according to Equation 13 is applied. This may be applied, for example in the Equation 7 for the method 100.

$$P = [ \begin{matrix}{P}_{{R}_{b}} & {0}_{2} \\ {0}_{2} & {P}_{S}\end{matrix} ] \qquad ( 13 )$$

When compared to conventional PtoP DSTTD systems, with pre-processing, the whole data to be transmitted may not be shared between the S 110, and R1 110 and/or R2 112 nodes. In other words, the R1 110 and/or R2 112 nodes do not have the entire current frame that is being transmitted from S 110.

When contrasted to pre-processing methods such as antenna shuffling and selection, the matrix P of Equation 13 performs pre-processing for the two. STBC frames of the S 102 and relay nodes independently. In addition to the block diagonal structure, a diagonal phase rotation matrix may be adapted using Equation 14, thus providing convenience in the pre-processing matrix design, as well as utilizing a moderate quantity of feedback information.

$${P}_{N} = [ \begin{matrix}{e}^{{jθ}_{N .1}} & 0 \\ 0 & {e}^{{jθ}_{N .2}}\end{matrix} ] \qquad ( 14 )$$

In Equation 14, θ_{N,n}ε[0,2π] rotates the phase of the signal from the nth antenna of the node N. Consequently, P_{N} may be used as the distributed pre-processing matrix P of Equation 13, It is noted that P_{N} is a diagonal matrix, and P_{N} may be designed to improve a post-processed SNR at the destination as follows.

The notation of SNRN₂N₁ is used to denote the SNR from a node N₁ to another node N₂, where N₁ε{S,Rₐ} and N₂ε{D,R_{b}}. The post-processed SNR may be expressed for DSTTD as

$$\begin{matrix}{SNR}_{{N}_{2} {N}_{1}} = \frac{1}{{[ {( {I}_{4} + {E}_{s} {σ}_{{N}_{2}}^{- 2} {S}_{{N}_{2}}^{* } ( t ) {S}_{{N}_{2}} ( t ) )}^{- 1} ]}_{l , l}} - 1 & ( 15 ) \\ and & \\ l = \{ \begin{matrix}1 or 2 , & if {N}_{1} = {R}_{a} \\ 3 or 4 , & if {N}_{1} = S\end{matrix} & ( 16 )\end{matrix}$$

By focusing the post-processed SNR at the D 120 node, the minimum SNRDN₁ may be bounded

min(SNR_{DN}_{₁})≧Eₛσ_{D}⁻²λₘᵢₙ(S_{D}(t)*S_{D}(t)) (17)

λₘᵢₙ(A) is the minimum eigenvalue of a matrix A.

The relay pre-processing matrix maximizing the lower bound of the minimum post-processing SNR of Equation 17 may be obtained from the optimization problem of Equation 18.

$$\{ {P}_{{R}_{b}}^{o} , {P}_{S}^{o} \} = arg {max}_{\{ {P}_{{R}_{b}} , {P}_{S} \}} {λ}_{min} ( {S}_{D} ( t ) * {S}_{D} ( t ) ) \qquad ( 18 )$$

Since the effective DSTTD channel matrix S_{D}(t) may be represented by

$${S}_{D} ( t ) = [ \begin{matrix}{h}_{{DR}_{b} , 1 , 1} ( t ) {e}^{{jθ}_{{R}_{b} .1}} & {h}_{{DR}_{b} .1 .2} ( t ) {e}^{{jθ}_{{R}_{b} , 2}} & {h}_{DS .1 , 1} ( t ) {e}^{{jθ}_{S .1}} & {h}_{DS .1 .2} ( t ) {e}^{{jθ}_{S .2}} \\ {h}_{{DR}_{b} .1 .2}^{*} ( t ) {e}^{- {jθ}_{{R}_{b} .2}} & - {h}_{{DR}_{b} .1 .2}^{*} ( t ) {e}^{- {jθ}_{{R}_{b} .1}} & {h}_{DS .1 .2}^{*} ( t ) {e}^{- {jθ}_{S .2}} & - {h}_{DS .1 .1}^{*} ( t ) {e}^{- {jθ}_{S .1}} \\ {h}_{{DR}_{b} .2 .1} ( t ) {e}^{{jθ}_{{R}_{b} .1}} & {h}_{{DR}_{b} .2 .2}^{*} ( t ) {e}^{{jθ}_{{R}_{b} .2}} & {h}_{DS .2 .1} ( t ) {e}^{{jθ}_{S .1}} & {h}_{DS .2 .2} ( t ) {e}^{{jθ}_{S .2}} \\ {h}_{{DR}_{b} .2 .2}^{*} ( t ) {e}^{- {jθ}_{{R}_{b} , 2}} & - {h}_{{DR}_{b} .2 .2}^{*} ( t ) {e}^{- {jθ}_{{R}_{b} .2}} & {h}_{DS .2 .2}^{*} ( t ) {e}^{- {jθ}_{S .2}} & - {h}_{DS , 2 , 1}^{*} ( t ) {e}^{- {jθ}_{S .1}}\end{matrix} ] \qquad ( 19 )$$

by substituting Equation 13 into Equation 7, the optimization formulation of Equation 18 can be reformulated as

$$\{ {θ}_{{R}_{b} , 1}^{o} , {θ}_{{R}_{b} , 2}^{o} , {θ}_{S , 1}^{o} , {θ}_{S , 2}^{o} \} = arg {max}_{\{ {θ}_{{R}_{b} .1} , {θ}_{{R}_{b} .2} , {θ}_{S .1} , {θ}_{S .2} \}} {λ}_{min} ( {S}_{D} ( t ) * {S}_{D} ( t ) ) \qquad ( 20 )$$

Further, by using the specific structure of the DSTTD matrix S_{D}(t) from Equation 19, the minimum eigenvalue of Equation 20 may be derived as

$${λ}_{min} ( {S}_{D} ( t ) * {S}_{D} ( t ) ) = \frac{{c}_{3} - \sqrt{{c}_{3}^{2} - 4 ( {c}_{1} {c}_{2} - η )}}{2} \qquad ( 21 )$$

where c₁=|s_{1,1}|²+|s_{1,2}|²+|s_{3,1}|²+|s_{3,2}|², c₂=|s_{1,3}|²+|s_{1,4}|²+|s_{3,3}|²+|s_{3,4}|², c₃=c₁+c₂, and

η=(|s_{1,1}|²+|s_{1,2}|²)(|s_{1,3}|²+|s_{1,4}|²)+(|s_{3,1}|²+|s_{3,2}|²)(|s_{3,3}|²+|s_{3,4}|²)+2Re{(s_{1,1}s_{1,3}+s_{1,2}s_{1,4})(s_{3,1}s_{3,3}+s_{3,2}s_{3,4})}+2Re{(s_{1,1}s_{1,4}−s_{1,2}s_{1,3})(s_{3,1}s_{3,4}−s_{3,2}s_{3,3})}
s_{i,j} denotes the (i,j)th entry of S_{D}(t).

Consequently, knowing that c₁, c₂, and c₃ are independent of θ_{N,m}, the optimization problem of Equation 20 may be rewritten as

$$\{ {θ}_{{R}_{b} , 1}^{o} , {θ}_{{R}_{b} , 2}^{o} , {θ}_{S , 1}^{o} , {θ}_{S , 2}^{o} \} = arg {max}_{\{ {θ}_{{R}_{b} .1} , {θ}_{{R}_{b} .2} , {θ}_{S .1} , {θ}_{S .2} \}} η \qquad ( 22 )$$

Applying the sum and difference identities of angle and trigonometric functions, i.e., cos(θ₁±θ₂)=cos θ₁ cos θ₂±sin θ₁ sin θ₂ and α cos θ±β sin θ=\sqrt{α²+β²} cos(θ−tan⁻¹ β/α), a condition for the optimal phase rotation minimizing η of Equation 22 may be derived as

$$\{ {θ}_{{R}_{b} , 1}^{o} + {θ}_{{R}_{b} , 2}^{o} - {θ}_{S , 1}^{o} - {θ}_{S , 2}^{o} \} = \{ \begin{matrix}\frac{3 π}{2} - {tan}^{- 1} ( \frac{Re ( p )}{Im ( p )} ) , & if Im ( p ) > 0 \\ \frac{π}{2} - {tan}^{- 1} ( \frac{Re ( p )}{Im ( p )} ) , & if Im ( p ) < 0\end{matrix} \qquad ( 23 )$$

where

p=(h*_{DR}_{_{b}}_{,1,1}(t)h*_{DR}_{_{b}}_{,2,2}(t)−h*_{DR}_{_{b}}_{,1,2}(t)h*_{DR}_{_{b}}_{,2,1}(t))(h_{DS,1,1}(t)h_{DS,2,2}(t)−h_{DS,1,2}(t)h_{DS,2,1}(t))

Without loss of generality, Equation 23 may be set to be θ_{R}_{_{b}}_{,2}^{o}=θ_{S,1}^{o}=θ_{S,2}^{o}=0. Thus, only relay pre-processing may remain to be considered. The D 120 node uses θ_{R}_{_{b}}_{,1}ε[0,2π] for computation in Equation 23. This may be done according to the channel state information (CSI) and is fed back to the R_{b} node for the relay pre-processing. The CSI may be estimated at D 120 by using the orthogonal training sequences. In order to reduce the amount of information feedback, θ_{R}_{_{b}}_{,1} may be considered to take on the values {0,π}. This may thus use only 1-bit to feedback information. This may thus provide the advantage of using a minimal amount of feedback information, but may still be effective for improving system performance.

### IV. Selection Scheme

Frame-by-frame ML detection may be performed independently for each frame. This may have the advantage of overcoming the computation complexity required for performing optimal ML sequence detection (MLSD). Performing optimal MLSD over T frames may be unfeasible in practice due to the tremendous computation complexity resulting from processing M^{2T} candidates (because there are T frames with symbols including M-bits).

Therefore, using Equations 8 and 10, it may be seen that the destination node D 120 may obtain two estimates for [x₁(t−1)x₂(t−1)]^{T} at a tth communication time for (t=2, . . . , T+1). In other words, the D 120 node knows the estimates [\hat{x}_{R}_{_{b}}_{,D,1}(t−1)\hat{x}_{R}_{_{b}}_{D,2}(t−1)]^{T} and [\hat{x}_{D,1}(t−1)\hat{x}_{D,2}(t−1)]^{T} through the tth and (t−1)th communications, respectively. The former estimate is derived from the received signal through a relay-link (i.e. a source-to-relay-to-destination link) and the latter estimate is derived from the received signal through a direct-link (i.e. a source-to-destination link). Thus, the detection performance for the two estimates may be different depending on the link conditions.

A link selection method according to the example embodiment may be used. The link selection method selects the most reliable estimate based on the post-processed SNRs of the direct links and relay links. It is noted that since the method 100 uses relays of the DF type, the soft combining of \hat{x}_{D,m}(t−1) with \hat{x}_{R}_{_{b}}_{,m}(t−1) may not be applicable.

In the link selection method, the selection criterion for the nth STBC symbol of (t−1)th frame is

$${\tilde{x}}_{n} ( t - 1 ) = \{ \begin{matrix}{\hat{x}}_{D , n} ( t - 1 ) , & if {SNR}_{DS} \geq min ( {SNR}_{{DR}_{b}} , {SNR}_{{R}_{b} S} ) \\ {\hat{x}}_{{R}_{b} , D , n} ( t - 1 ) , & if {SNR}_{DS} < min ( {SNR}_{{DR}_{b}} , {SNR}_{{R}_{b} S} )\end{matrix} \qquad ( 24 )$$

This selection criterion may work well for a ML receiver in spite of the post-processed SNR being derived using the assumption that linear processing is performed. The dominant factors for the system performance are the link gains {σ_{N}_{₂}_{N}_{₂}²}, which are tightly related to the post-processed SNR in Equation 15. This may be seen in numerical results to be presented later.

In order to perform the link selection, the SNR information may be used at the destination node. The SNR_{Ds} and SNR_{DRb} may be estimated at the D 120 node, while SNR_{Rbs} may be obtained at the R_{b} node and fed back from the R_{b} node to the D 120 node. Thus, while additional signalling may be required for the feedback, signal performance enhancements may however be obtained.

At least two frame length memories may be required at the D 120 node in order for the selection to be carried out. However, no selection at each relay may need to be carried out since each relay retransmits the signal received from S 102 in each subsequent transmission time.

### V. Cell Planning and Frame Structure

Relay nodes may be located close to each other, in which case the strong interference amongst the relay nodes may deteriorate the relay signals. Thus, meticulous planning may be required when deploying the relays in cellular systems.

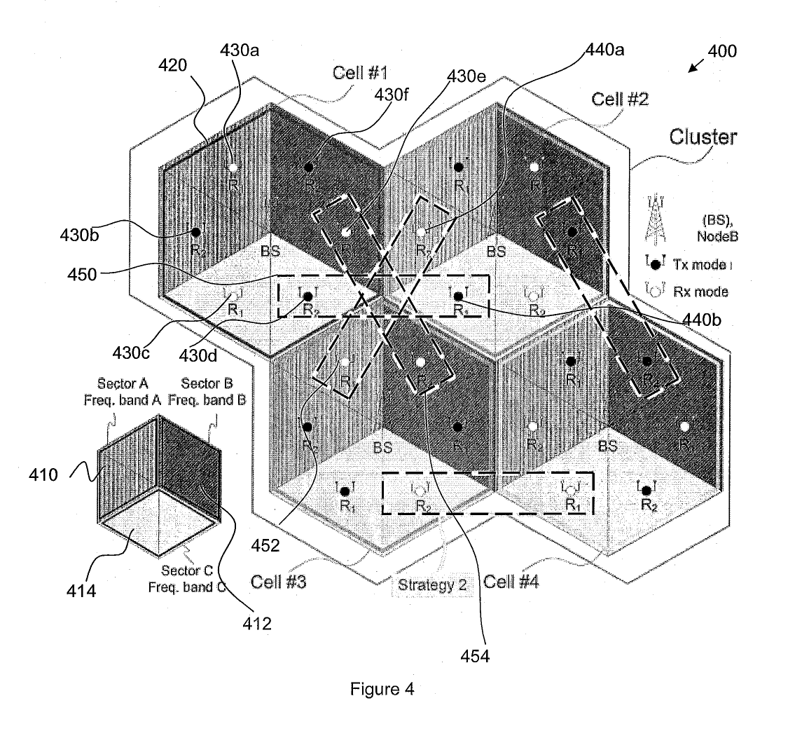

FIG. 4 thus shows an efficient cell plan 400 according to the example embodiment. Four cells respectively labelled Cell #1 to Cell #4 are shown. Each cell is made up of three sectors and each sector has two relays. As an example, Cell #1 thus has six relays 430a to 430f. The cell plan 400 may have the advantage of avoiding inter-cell interference (ICI) arising when the proposed DSTTD-based two-path relay systems is applied to the cellular environment. Optionally, inter-relay interference may also be removed by employing DSTTD detection at the relay nodes.

The cell plan 400 may use two strategies.

### Strategy 1:

Use three sectors in order to increase the degree of freedom for relay deployment with less interference.

### Strategy 2:

Use the same communication mode (i.e. to function either as transmitters or receivers) for the nearest two relays who use the same frequency but are located in different cells.

In accordance with Strategy 1, the cell plan 400 has three sectors, i.e. Sectors A 410, B 412, and C 414, using orthogonal frequency bands respectively also labelled A, B, and C. A two-path relay deploy method is also used in the cellular environment shown where each sector has the two relay nodes. Taking sector 420 of Cell #1 as an example, that sector 420 has two relays R1 430a and R2 430b performing DSTTD-based two-path communications.

In accordance with Strategy 2, the neighbouring sectors of different cells sharing the same frequency are also arranged to avoid interference by ensuring that the nearest two relays in the respective neighbouring sectors are designated to be the same mode. As an example, Cell #1 and Cell #3 are neighbours and sector B 412 shares the same frequency band. Relay 430e of sector B Cell #1 is nearest to the relay 454 of sector B Cell #3. The relays 430e and 454 are thus designated to function similarly as receivers (i.e. Rx mode relay) in the same time slot and same frequency band. Similarly, the relay 430d of sector C Cell #1 is nearest to the relay 440b of sector C Cell #2. The relays 430d and 440b are thus designated to function similarly as transmitters (i.e. Tx mode relay) during the same time slot and same frequency band.

Such an arrangement may confer the advantage where every relay avoids strong interference from the nearest neighbouring relays, i.e. the interferences between relay pairs as shown reflected by the dotted boxes 450, 452, 454.

This design method may also result in a cluster structure with four cells i.e. Cell #1 to Cell #4.

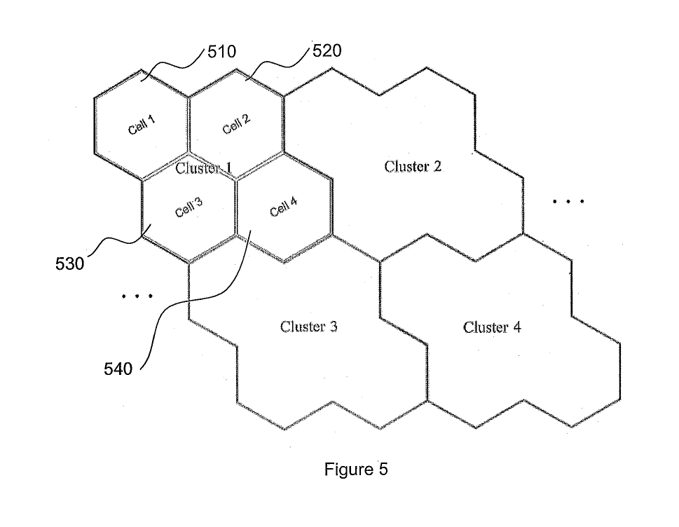

FIG. 5 shows a cluster structure for the cell plan 400 according to the example embodiment. It shows a possible way of arranging the clusters in a repeatable manner. It also shows that each cluster may comprise four cells, e.g. Cluster 1 comprises the cells 510 to 540.

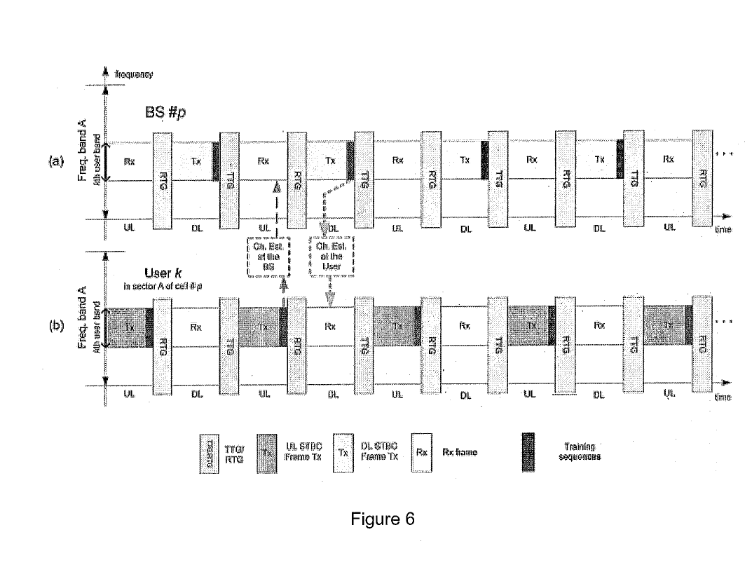

FIG. 6 shows the spectrum usage of a conventional point-to-point TDD/OFDMA communications for a kth user in a Sector A 410 of a pth cell, where FIG. 6(a) shows that for a frame for a base station, and FIG. 6(b) shows that for a user node. The vertical axis reflects the frequency domain while the horizontal axis reflects the time domain. The Transmit/receive Transition Gap (TTG) is required to switch from transmit to receive mode and the Receive/transmit Transition gap (RTG) is required to switch from receive to transmit mode.

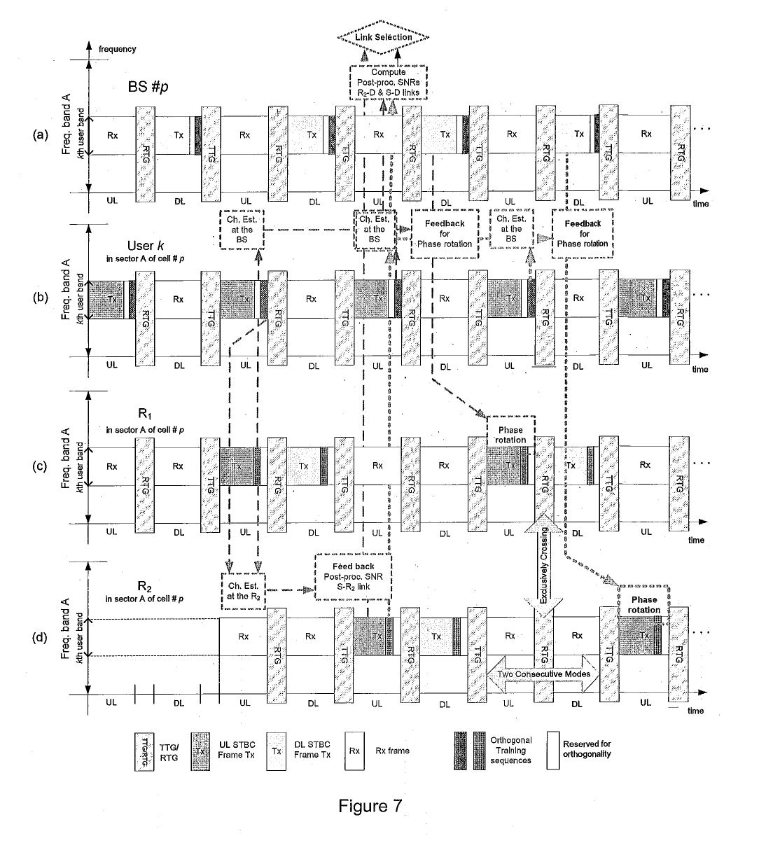

FIG. 7 shows the spectrum usage of TDD/OFDMA communications for a kth user in a Sector A 410 of a pth cell according to an example embodiment, where FIG. 7(a) shows that for a frame for a base station, FIG. 7(b) shows that for a frame for a user node, FIG. 7(c) shows that for a frame for a first relay node, and FIG. 7(d) shows that for a frame for a second relay node. Phase rotations and link selections are shown only for uplink communications. The vertical axis reflects the frequency domain while the horizontal axis reflects the time domain.

The logical frame structures for the uplink (UL), downlink (DL), and feedback communications may be interpreted from FIG. 7. UL communications are defined to be data transmission from the users to the base station (BS), while DL communications are defined to be data transmission from the BS to the users. It is understood that for DL communications, the BS would be the S 102 while the users would be the D 120. For UL communications, the BS would be the D 120 while the users would be the S 102. In both cases, it is also understood that the relays R1 and R2 may be users or base stations.

As can be seen, FIG. 7(b) depicts the UL communications for the kth user in the sector A of the pth cell. A kth user in a sector A may use a certain portion of band which is orthogonal to other users within the same frequency band A. By tracing the dotted paths in FIG. 7, It can be seen as to how and when the destination and relay nodes obtain information for link selection and/or phase rotation.

Also, it is noted that the downlink communication protocol is reciprocal to the uplink communication protocol, so that we can get downlink frame structure by switching BS #p in FIG. 7(a) and user k in FIG. 7(b). Therefore, as shown in FIG. 7(d), two consecutive Tx or Rx modes are designed for one relay and as shown in FIGS. 7(c) and (d), an exclusively crossing Tx and Rx mode is designed across both two relays R1 and R2

### VI. Simulation Results

In this section the Bit Error Rate (BER) performance of the DSTTD-based two-path relay method 100 is described.

In the performance evaluations, the following assumptions are made. Each node is assumed to have two antennae, each transmit antenna of the S 102 and relay nodes R1 110 and R2 112 consumes an average transmit power P, and quadratic PSK (QPSK) modulation is used. It is assumed that a frame includes 80 QPSK symbols, i.e., 20 STBC blocks (L=20), and the MIMO channel matrix H_{N2N1} is generated from independent Gaussian random variables with zero mean and σ_{N}_{₂}_{N}_{₂}² variance. N1ε{S,R1,R2} and N2ε{D,R1,R2}. Channels are fixed during one frame, but may vary independently over frame. Additionally, for the sake of comparison, the performance of a PtoP system without relays is included in the plots and labelled “PtoP STBC”. For a fair comparison, the average transmit power for each antenna of the “PtoP STBC” system is set to be twice as much as the transmit power of the two-path relay systems, i.e., each transmit antenna of the “PtoP STBC” transmitter uses an average transmit power of 2P. In the simulations, the received SNR from the N₁ node to the N₂ node is defined as

$${RxSNR}_{{N}_{2} {N}_{1}} {=}^{Δ} \frac{{E}_{s} {σ}_{{N}_{2} {N}_{1}}^{2}}{{σ}_{{N}_{2}}^{2}} \qquad ( 25 )$$

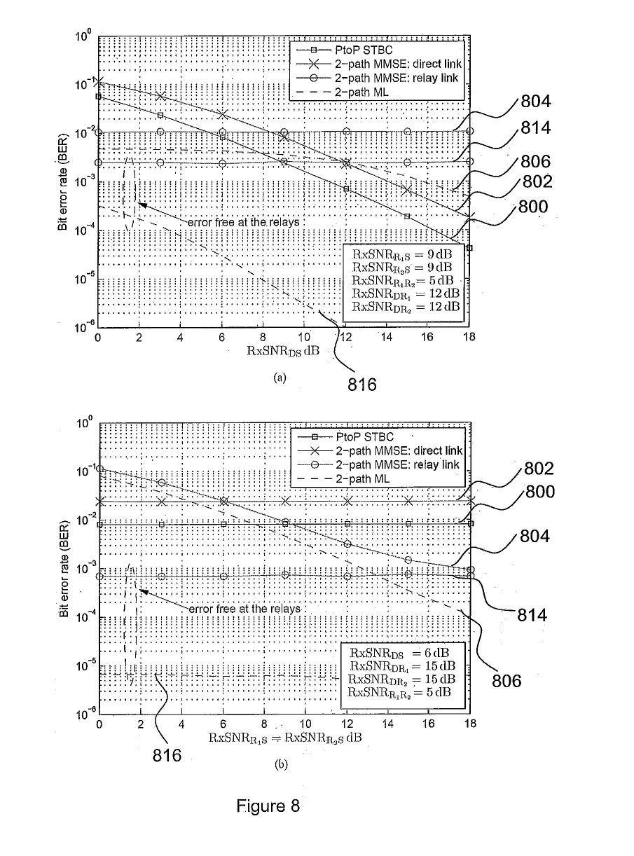

FIG. 8 shows the BER performance of the direct and relay links in DSTTD-based two-path relay communications according to the example embodiment. FIG. 8(a) shows the performance when the received SNR for the link from the S 102 to the D 120 is varied. FIG. 8(b) shows the performance when the received SNRs for the links from the S 102 to the relays R1 110 or R2 112 are varied. In both FIGS. 8(a) and 8(b), the curve 800 shows the performance for a “PtoP STBC” transmitter. The curve 802 shows the performance for a 2-path direct link using MMSE estimation. The curve 804 shows the performance for a 2-path relay link using MMSE estimation. The curve 806 shows the performance for a 2-path using ML joint-link estimation. The curves 814 and 816 respectively show the same type of performance results as the curve 804 and 806, except that for curves 814 and 816, the estimation done at the relays are error free.

For comparison with the optimal MLSD systems, the number of frames is set to be two (T=2) for each communications. The results are then obtained as the average of 10⁵ communications realizations. In the MLSD system, the relays R1 110 and R2 112 employ a ML detector for the first STBC frame, and the destination D 120 detects jointly the first and second frames under the assumption: that the relays correctly detect the first frame and retransmits it.

As can be seen from the curve 816, if there is no error at the relay nodes, ML-based scheme can achieve the best performance. Otherwise, it can be seen from curve 806 that the performance of a ML-based scheme is worse than other schemes for certain received SNR values. As an example, when the relay links min{RxSNR_{RaS},RxSNR_{DRa}} are poorer compared to the direct link RxSNR_{DS} i.e. in the right (RxSNR_{DS}≧12 dB) and left (RxSNR_{DR1}=RxSNR_{DR2}≦6 dB) regions of FIGS. 8(a) and 8(b) respectively, the direct-link communications with the MMSE-based linear detector (i.e. curve 802) performs better than the joint-link communications with the ML-based detector (i.e. curve 806).

The performance of the PtoP STBC system (i.e. curve 800) obtains a reasonable performance gain compared to the direct link communications with linear detector (i.e. curve 802). This tendency may come from the fact that the only difference between them is the transmitting power at the S 102 node, i.e. because the average transmitting power for curve 800 is twice that for curve 802. From these results, it may be seen that utilizing link selection between the relay and direct links may be advantageous.

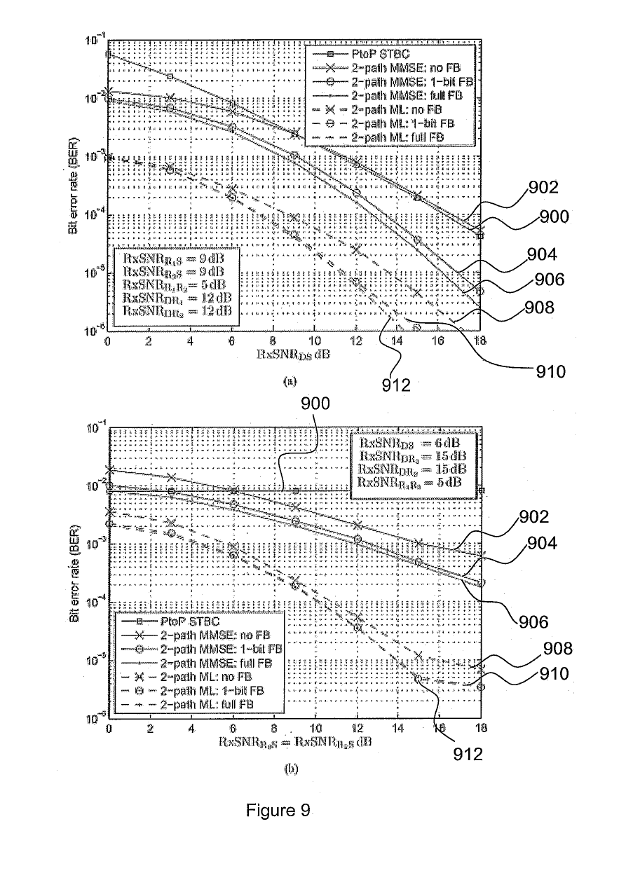

FIG. 9 shows the BER performance of DSTTD-based two-path relay communications with a link selection according to the example embodiment where there is no feedback (FB), 1-bit FB or full FB. FIG. 9(a) shows the performance when the received SNR for the link from the S 102 to the D 120 is varied. FIG. 9(b) shows the performance when the received SNRs for the links from the S 102 to the relays R1 110 or R2 112 are varied. In both FIGS. 9(a) and 9(b), the curve. 900 shows the performance for a “PtoP STBC” transmitter. The curves 902, 904 and 906 respectively show the performance for a 2-path relay link using MMSE estimation where there is no FB from D 120 to the relays R1 110 or R2 112, where there is a 1-bit FB from D 120 to the relays, and where there is full FB from D 120 to the relays. The curves 908, 910 and 912 respectively show the same type of performance results as the curves 902, 904 and 906, except that the results are for a 2-path relay link using ML estimation.

Where there is full FB, the relays know the exact values of θ_{R,1}^{o} for the phase rotation. The results are then obtained as the average of 10⁵ transmissions, i.e. T=10⁵. The relays and source in the ML-based systems perform frame-by-frame ML detection instead of sequential detection.

From the result shown in FIG. 9, we can see the performance enhancement provided by the link selection (compare 902 with 908) as well as further performance improvement from phase rotation (compare 900 with 904 and 906, or compare 908 with 900 and 912). The two-path systems with MMSE detector (i.e. curves 902, 904 and 906) achieve worse performance compared to the PtoP system (i.e. curve 900) in certain SNR region, for example where the RxSNR_{DS} is greater than 9 dB, the curve 900 reflects better performance than the curve 902. It can also be seen that the ML-based systems (i.e. curves 908, 910 and 912) show better performance than the MMSE detector based systems (i.e. curves 902, 904 and 906) or the PtoP system (i.e. curve 900) for all SNR values used in the simulation. In the case of the PtoP system (i.e. curve 900), the ML-based systems may achieve a SNR gain of about over 8 dB. Further, it can be seen that the performance gaps between systems using full FB and 1-bit FB with ML detectors (i.e. the performance gap between curves 910 and 912) is smaller than the same performance gap for MMSE-based systems (i.e. the gap between curves 904 and 906).

The described embodiments should not be construed as limitative. For example, the described embodiments describe the DSTTD relay as a method but it would be apparent that the method may be implemented as a device, more specifically as an Integrated Circuit (IC). In this case, the IC may include a processing unit configured to perform the various method steps discussed earlier, but otherwise operate according to the relevant communication protocol. For example the described embodiment is particularly useful in a cellular network, such as a 4G network, but it should be apparent that the described embodiment may also be used in other wireless communication networks. Thus mobile station devices, base station and other network infrastructure may incorporate such ICs or otherwise be programmed or configured to operate according to the described method.

Whilst example embodiments of the invention have been described in detail, many variations are possible within the scope of the invention as will be clear to a skilled reader. For example, it should be appreciated that whilst the source, relays and destination are described as having specific and distinct roles in the method, they may however be implemented using similar hardware. Optionally, the sources, relays and destinations may interchange their roles and functions between each other and/or between other groups of sources, relays and destinations in an ad-hoc manner, for example where a source or destination may act as a relay, or a source and a destination exchange roles.

1. A method of communication comprising:
At time=t:
a first multiple antenna relay node decoding and forwarding a first STBC coded signal from a source node, and a first decoded and forwarded STBC signal from a second multiple antenna relay node, and
a destination DSTTD receiver decoding the first STBC coded signal from the source node, and the first decoded and forwarded STBC signal from the second multiple antenna relay node;
At time=t+1:
the second multiple antenna relay node receiving a second STBC coded signal from the source node, and a second decoded and forwarded signal from the first multiple antenna relay node, and
the destination DSTTD receiver decoding the second STBC coded signal from the source node, and the second decoded and forwarded signal from the first multiple antenna relay node.

2. The method in claim 1 further comprising phase rotation pre-processing.

3. The method of claim 1 further comprising optimising a pre-processing matrix based on a post-processed SNR.

4. The method in claim 1 further comprising selecting a either a direct link or a relay link based on a post-processed SNR at the destination DSTTD receiver.

5. The method in claim 1 wherein the decoding and forwarding includes DSTTD detection.

6. The method in claim 1 further comprising channel estimating based on an orthogonal training sequence in a frame structure for each of the STBC coded signals and decoded and forwarded signal signals.

7. The method in claim 1 further comprising dividing a cell into sectors, each sector having an orthogonal frequency band, and selecting the first multiple antenna relay node and the second multiple antenna relay node within each sector.

8. The method in claim 7 further comprising forming a cluster out of a plurality of adjacent cells, wherein a first sector in a first cell and a second sector in a second cell shares the same frequency band, and wherein selecting the first multiple antenna relay node and the second multiple antenna relay node comprises selecting a relay node in the first sector that is closest to the second sector as either the first multiple antenna relay node or the second multiple antenna relay node, and selecting a relay node in the second sector that is closest to the first sector as the either the second multiple antenna relay node or the first multiple antenna relay node respectively.

9. The method in claim 1 wherein the STBC coded signals and decoded and forwarded signal signals comprise a two-path relay time-division-duplex (TDD) frame structure, wherein the frame structure includes slots for uplink data transfer, downlink data transfer feedback on phase rotation, and feedback on link selection.

10. The method in claim 1 further comprising bi-directional communication including an uplink and a downlink.

11. An integrated circuit configured to communicate according to a method of communication comprising:
At time=t:
a first multiple antenna relay node decoding and forwarding a first STBC coded signal from a source node, and a first decoded and forwarded STBC signal from a second multiple antenna relay node, and
a destination DSTTD receiver decoding the first STBC coded signal from the source node, and the first decoded and forwarded STBC signal from the second multiple antenna relay node;
At time=t+1:
the second multiple antenna relay node receiving a second STBC coded signal from the source node, and a second decoded and forwarded signal from the first multiple antenna relay node, and
the destination DSTTD receiver decoding the second STBC coded signal from the source node, and the second decoded and forwarded signal from the first multiple antenna relay node.

12. A mobile station configured to communicate according to a method of communication comprising:
At time=t:
a first multiple antenna relay node decoding and forwarding a first STBC coded signal from a source node, and a first decoded and forwarded STBC signal from a second multiple antenna relay node, and
a destination DSTTD receiver decoding the first STBC coded signal from the source node, and the first decoded and forwarded STBC signal from the second multiple antenna relay node;
At time=t+1:
the second multiple antenna relay node receiving a second STBC coded signal from the source node, and a second decoded and forwarded signal from the first multiple antenna relay node, and
the destination DSTTD receiver decoding the second STBC coded signal from the source node, and the second decoded and forwarded signal from the first multiple antenna relay node.

13. A base station configured to communicate according to a method of communication comprising:
At time=t:
a first multiple antenna relay node decoding and forwarding a first STBC coded signal from a source node, and a first decoded and forwarded STBC signal from a second multiple antenna relay node, and
a destination DSTTD receiver decoding the first STBC coded signal from the source node, and the first decoded and forwarded STBC signal from the second multiple antenna relay node;
At time=t+1:
the second multiple antenna relay node receiving a second STBC coded signal from the source node, and a second decoded and forwarded signal from the first multiple antenna relay node, and
the destination DSTTD receiver decoding the second STBC coded signal from the source node, and the second decoded and forwarded signal from the first multiple antenna relay node.

14. A relay station configured to communicate according to a method of communication comprising:
At time=t:
a first multiple antenna relay node decoding and forwarding a first STBC coded signal from a source node, and a first decoded and forwarded STBC signal from a second multiple antenna relay node, and
a destination DSTTD receiver decoding the first STBC coded signal from the source node, and the first decoded and forwarded STBC signal from the second multiple antenna relay node;
At time=t+1:
the second multiple antenna relay node receiving a second STBC coded signal from the source node, and a second decoded and forwarded signal from the first multiple antenna relay node, and
the destination DSTTD receiver decoding the second STBC coded signal from the source node, and the second decoded and forwarded signal from the first multiple antenna relay node.

15. A communication system comprising
a multiple antenna source configured to transmit STBC coded signals
at least two multiple antenna DSTTD relay nodes configured to alternatively decode and forward the STBC coded signals, and
a DSTTD receiver configured to decode the STBC coded signals and the relayed signals.
